(19) United States
(12) Patent Application Publication
(10) Pub. No.: US 2003/0218625 A1
(43) Pub. Date: Nov. 27, 2003

(54) Streaming video digital sports directory

(76) Inventor: Kevin Allison, Torrance, CA (US)

Correspondence Address: KEVIN ALLISON, UNIT F, 23234 SESAME ST., TORRANCE, CA, 90502, US

(21) Appl. No.: 10/153,280

(22) Filed: May 22, 2002

(51) Int. Cl. G09G 5/00

(52) U.S. Cl. 345/716

(57) ABSTRACT

The present invention is a graphical user interface (1a,1b) for recruiters of all sports. It is The Digital Sports Directory for subscriber internet access, including DSL and Broadband cable. A screen is provided with menus of icons(65) for the function of downloading multi media streaming video showcasing individual workouts (50a) in streaming video of athletes performing position specific, agility, power and speed drills. The multi media includes highlights from actual games played by the potential recruit. Other sections of the screen provide presentations of various text data(60) included in The Digital Sports Directory.

### FEDRALLY SPONSORED RESEARCH

Not applicable

### SEQUENCE LISTING PROGRAM

Not applicable.

### BACKGROUND—FIELD OF INVENTION

Sports related internet assistance to recruiting athletes.

### BACKGROUND—DESCRIPTION OF PRIOR ART

Today the recruiting method for on line services is two dimensional. The viewer only gets to see a still picture and read statistics. The other methods are “word of mouth” which could take weeks perhaps months until a recruiter hears about a player's abilities as a potential recruit. Another method of recruitment is called a questionnaire which is sent to an athlete in the form of a letter from colleges. In this letter colleges and university's ask the potential recruit about their size, speed, and grades. The questionnaire is filled out and mailed back to the colleges, and this procedure adds weeks to the process. The current recruiting process causes many athletes to go unnoticed and this is a tragic loss.

Furthermore, recruiters can rarely have physical contact with potential athletes. Often times, since the recruiting world is so full of “word of mouth” endorsements and grainy highlight videos, a recruiter will travel for miles to finally meet a recruit. Many times they like what they find but often times they discover that the recruit is too small too skinny or not strong enough. The methods of recruiting have stifled the Fluidity needed in evaluating known and unknown players.

Objects and Advantages

Accordingly, besides the objects and advantages of online recruiting described in my above patent, several objective and advantages of the present inventions are:

(A) To provide all the players game highlights in streaming video. See all the players' individual and team accomplishments.

(B) To provide streaming video of the players work outs recorded in streaming video. See a player running the forty yard dash.

(C) To provide the actual clock as we record how fast a player really is.

(D) To provide streaming video on the vertical leaping ability of a player.

(E) To provide measurement that shows how high the player jumps.

(F) To provide streaming video of how much weight a player can lift.

(G) To provide streaming video of interviews with the players, coaches, and teachers.

(H) To provide, SAT, ACT scores and school grades.

Further objects and advantages are to provide recruiters with the best athlete for their team. A recruiter could easily rebuild an athletic program using The Digital Sports Directory. By simply specifying what they are looking for, a recruiter who logs onto to the Sport Digital USA.com will get to see a private personal work-out from top athletes around the world.

### SUMMARY

The Digital Sports Directory will revolutionize recruitment by broadening the scope to unlimited bounds via the internet. By using our methods we will change recruiting forever. With a computer and access to high-speed internet a recruiter can log-on to our Directory and find the athlete they need.

### DRAWINGS

### Drawings/Figures

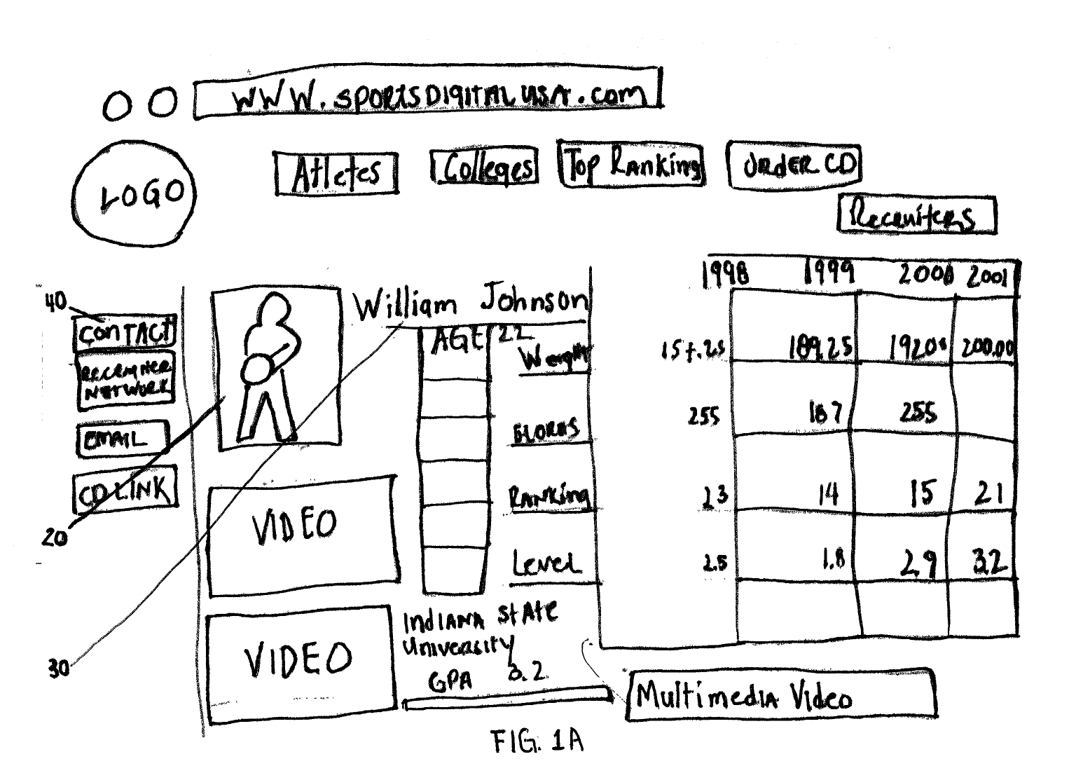

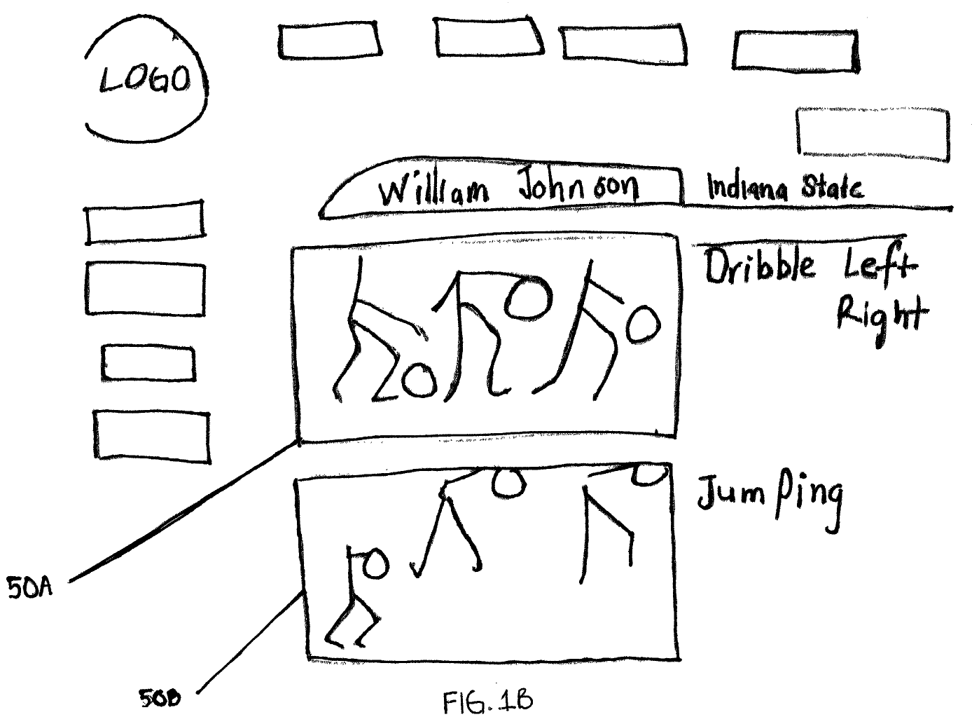

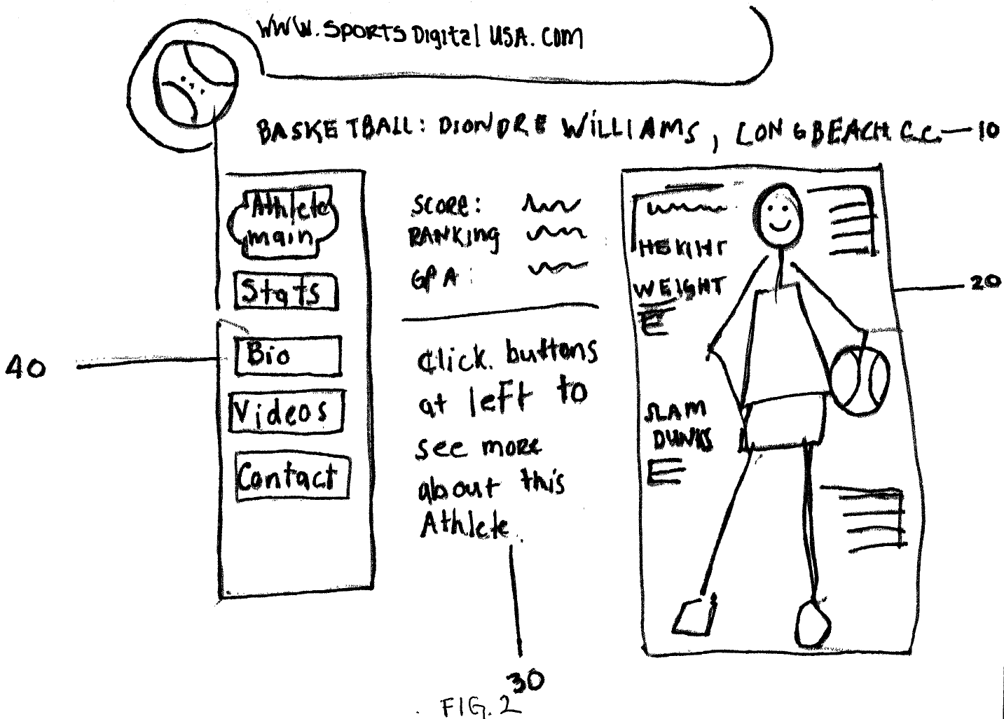

In the drawings, closely related figures have the same numbers but different suffixes. FIGS. 1a and 1b shows various aspects of the Sports Directory's interface. FIG. 1a interface showing the athlete's bio, including stats and scores. FIG. 1b shows the athlete performing a workout in streaming video. FIG. 2 shows the interface's directory featured athlete.

Reference Numerals in Drawings

| | | | |
|---|---|---|---|
| 20 | The picture of the athlete | 10 | The athlete's name |
| 40 | The contact numbers and order | 60 | The athlete's statistics |
| | forms | | |
| 50a | The athletes streaming video | 50b | The athlete's streaming |
| | workout. | | video workout |
| 65 | The (GUI) interface with logo | | |
| | and design | | |

### DETAILED DESCRIPTION

### Description—FIGS. 1a, 1b, and 2—Preferred Embodiment

A preferred embodiment of The SportsDigital Directory of the present invention is illustrated in FIGS. 1a, 1b, and FIG. 2. All that is needed are the basic desktop computer. digital camera soft wear, and a Director 8 interactive adobe Premier built into a network System. FIGS. 1a, 1b A Graphic user interface with buttons, links, text, and working element media of the athletes' statistics and grades, 60 will be combined with logo's design,65 additional elements, and photos and real-time video 1b.

### FIGS. 1a, 1b, and 2—Additional Embodiments

Additional embodiments is a lap-top computer. This is an excellent way to travel and stay connected. The lap-top shall have digital camera software, Director 8 interactive Adobe Premier built into a networking system. FIGS. 1a, 1b, and FIG. 2 A designed interface with buttons links, contact number and order form,20 text Working element media, the athletes statistics and grades,60. Will be combined with logo's designs,65 additional elements, and photos and real-time footage 1b.

Advantages

From the description above, a number of advantages of my Digital Sports Directory become evident:

(A) We have interactive visual profiles. These profiles are videoed and viewed in steaming video at real-time. The recruiter will see visuals of the athlete performing position specific agility drills timed and recorded at numerous camera angles give a surreal digital appeal.

(B)A recruiter can streamline the fiscal bottom line. Recruiters will optimize their calendars by using The Sport Digital Directory; and then they can incur less travel time and experience a broader scope for recruiting quality players.

(C)A recruiter will have access to game highlights, interviews with the coaches, relatives, and friends.

(D)A recruiters will have access to grades test scores ACT and SAT scores.

(E)The Digital Sports Directory gives national exposure to student athletes wishing to increase their chances at going to great schools.

### FIGS. 1a, 1b, and 2—Operation—Preferred

The manner of using the Sports Directory is easy, all media will be access from the database with interconnection to DSL or Broadband. Media will allow access to statistics and text data FIGS. 1a, 1b, and 2. Media includes video and pictures 1b. text Data. Recruiters can access all information in streaming video. Workouts, highlights, and interviews 50a, 50b (1b) and body measurements (1a)

### FIGS. 1a, 1b, and 2—Operation—Additional

If the recruiter's computer is not up to par with the bandwidth necessary for viewing the Streaming video media, they then can easily go on-line and order the DVD and it will be delivered via mail. The DVD is fully interactive with the media combined to give stats30(1a.) Workouts, highlights, interviews50a, 50b (1b) and body measurements(1a.)

### CONCLUSIONS, RAMIFICATIONS, and SCOPE

Accordingly, the reader will see that the ability to be anywhere in the world and continue to scout talent without wasted energy can save money also increased winning programs in athletics. An athlete can broaden their market value. Unknowns can be discovered, whereby increasing the educational growth of people that are awarded scholarships. Colleges will receive more support in identifying human talent. In addition, this directory is an information articulation service that can effectively allow the trained and untrained eyes to evaluate the athlete. What is gained, is accuracy in the connection of student athletes and collegian recruiters. Furthermore, The Digital Directory has additional advantages in that:

It permits fluidity in evaluating the progression of a potential recruit. A recruiter can communicate to the potential recruit via e-mail and tell them that, they have seen the work-out and are very impressed. If the potential recruit is too slow or too weak, the potential recruit has the option of adding new footage to the directory. This allows the potential recruits to improve and place new results. Not only will this speak volumes about the potential recruits commitment to a disciplined work ethic but it will also show growth.

It allows the recruiter to monitor the potential athlete consistently or intermittently throughout the season.

It permits the athlete to post their latest feats each time they have a spectacular game. The highlight section is always updated to showcase the potential recruits adeptness, understanding, and ability to play the game in which they are being recruited.

It provides superior vantage point in which to survey and compile statistics of athletes around the globe.

It provides a technological business method that could be licensed to high schools and colleges and even used by scouts of professional sports.

It provides the meeting ground so that new ways of exchanging information can be done in cyber-space.

Although the description above contains much specificity, these should not be construed as limiting the scope of the invention but as merely providing illustrations of some of the presently preferred embodiments of this invention. For example, The data base can be burned to DVD .

Thus the scope of this invention should be determined by the appended claims and their legal equivalent, rather than by the example given.

I claim:

1. Providing a graphic user interface (GUI) for multi-media directory of streaming video of human athletes so that, humans can recruit said human athletes. The data based wherein said multi-media directory contains means for a digital library of said streaming video to be access by humans, whereby improving on-line sports recruiting.

2. The multi-media directory of claim 1 wherein said directory displays a GUI and files of said streaming video access by means of point and click of a mouse.

3. The GUI in claim 2 wherein said streaming video is a means for displaying athlete's work-outs training habits interviews and game highlights.

4. The streaming video in claim 3 wherein said workouts will provide the vertical leaping ability of said athlete as a means for a recruiter to evaluate said athlete jumping ability.

5. The streaming video in claim 1 wherein said workouts will provide said athletes weight lifting abilities as a means for a recruiter to verify the strength of said athlete.

6. The multi-media directory in claim 1 wherein said streaming video will provide said athletes game highlights as means for a recruiter to evaluate said athletes' caliber and potential

7. The multi-media directory in claim 1 wherein said streaming video will provide said athletes running wind sprints while being timed as a means for a recruiter to witness the said athletes' speed.

9. The multi-media directory in claim 1 wherein said streaming video will provide the said athlete ability to throw, catch, shoot, hit, and dribble as a means for a recruiter to witness said athletes' caliber.

10. The multi-media directory claim 1 wherein said streaming video will provide interviews with said athlete, as a means for the recruiter to become familiar with said athlete.

11. The multi-media directory in claim 1 wherein said streaming video will provide footwork agility drills as a means for a recruiter to determine said athletes quickness, reactions and reflexes.

12. The multi-media directory in claim 1 wherein said streaming video will provide a clock for all workouts as a means for determining the speed of human movement.

13. The multi-media directory in claim 1 wherein said streaming video will provide text data of said athletes' game statistics, ACT and SAT test scores as a means to articulate to recruiters said athletes' school admission potential.

14. The multi-media directory in claim 1 wherein said streaming video will provide body measurement of said athletes as a means for determining the physicality of said athlete.
